(19) United States
(12) Patent Application Publication
(10) Pub. No.: US 2013/0021161 A1
(43) Pub. Date: Jan. 24, 2013

(54) INDICATION CIRCUIT FOR INDICATING RUNNING STATUS OF ELECTRONIC DEVICES

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/427,889

(22) Filed: Mar. 23, 2012

(30) Foreign Application Priority Data
Jul. 22, 2011 (CN) 201110206525.7

(51) Int. Cl. G08B 21/00

(52) U.S. Cl. 340/635

(57) ABSTRACT

An indication circuit for an electronic device includes a control circuit, at least one LED, and at least one buffer register electronically connected between the control circuit and the at least one LED. The control circuit outputs control signals according to a running status of the electronic device, the at least one buffer register receives the control signals, and outputs voltage signals to turn on/off the at least one LED according to the control signals.

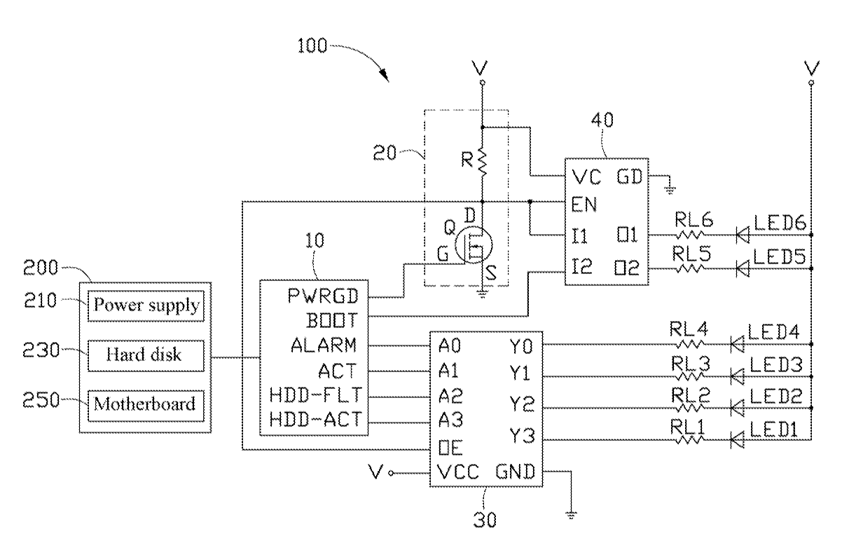

### BACKGROUND

1. Technical field

The disclosure generally relates to indication circuits, and more particularly relates to an indication circuit for indicating running status of electronic devices.

2. Description of the Related Art

Most electronic devices, such as desktops or servers, often have a motherboard, a hard disk, a power supply, and other components. Since the components are positioned inside a chassis of the electronic device, it is difficult to directly get the running status of the components. When the electronic device malfunctions, it is very inconvenient for users to have to open the chassis to check the components one at a time.

Therefore, there is room for improvement within the art.

### BRIEF DESCRIPTION OF THE DRAWINGS

Many aspects of an exemplary indication circuit for indicating running status of electronic devices can be better understood with reference to the drawing. The components in the drawing are not necessarily drawn to scale, the emphasis instead being placed upon clearly illustrating the principles of the disclosure.

The FIGURE is a circuit view of an indication circuit for indicating running status of electronic devices, according to an exemplary embodiment.

### DETAILED DESCRIPTION

The figure shows an indication circuit 100, which can be used in an electronic device 200, such as personal computer, server, or any other devices, for showing the running status of components of the electronic device 200. In one exemplary embodiment, the indication circuit 100 is used to show the running status of a power supply 210, a hard disk 230, and a motherboard 250 of the electronic device 200.

The indication circuit 100 includes a control circuit 10, a switch circuit 20, a first buffer register 30, a second buffer register 40, a number of current-limiting resistors, and a number of light-emitting diodes (LEDs). In one exemplary embodiment, the number of the current-limiting resistors is six, and are respectively labeled as RL1, RL2, RL3, RL4, RL5, and RL6. The number of the LEDs is six, and are respectively labeled as LED1, LED2, LED3, LED4, LED5, and LED6.

The control circuit 10 includes a first hard disk data pin HDD-ACT, a second hard disk data pin HDD-FLT, a power data pin PWRGD, a bootstrap program data pin BOOT, a system running data pin ACT, and an alarm data pin ALARM.

The control circuit 10 outputs different control signals according to the running status of the electronic device 200. For example, In one exemplary embodiment, the control circuit 10 outputs predetermined control signals according to the running status of the power supply 210, the hard disk 230, and the motherboard 250 in the electronic device 200. If a voltage of the power supply 210 is normal, the power data pin PWRGD outputs a high voltage signal (e.g., 5V). If the voltage is abnormal, the power data pin PWRGD outputs a low voltage signal (e.g., 3V). If the hard disk 230 is idle, the first hard disk data pin HDD-ACT outputs a low voltage signal (e.g., 3V). If the hard disk 230 is receiving/transmitting data, the first hard disk data pin HDD-ACT outputs pulses. If the hard disk 230 is disabled, the second hard disk data pin HDD-FLT outputs a low voltage signal (e.g., 3V). If the hard disk 230 is not installed, both of the first hard disk data pin HDD-ACT and the second hard disk data pin HDD-FLT output a high voltage signal (e.g., 5V). If an operating system (OS) of the electronic device 200 is loading, the bootstrap program data pin BOOT outputs a low voltage signal (e.g., 3V). If the electronic device 200 lacks a bootstrap program or the operating system has started, the bootstrap program data pin BOOT outputs a high voltage signal (e.g., 5V). If the motherboard 250 is operated normal or processing data, the system running data pin ACT outputs a low voltage signal (e.g., 3V); if the motherboard 250 is in a sleep mode or the power supply 210 is cut off, the system running data pin ACT outputs a high voltage signal (e.g., 5V). If the motherboard 250 malfunctions, the alarm data pin ALARM outputs a low voltage signal (e.g., 3V).

The switch circuit 20 includes a metallic oxide semiconductor field effect transistor (MOSFET) Q and a resistor R. The MOSFET Q includes a gate G, a source S, and a drain D. The gate G is electronically connected to the power data pin PWRGD of the control circuit 10, the source S is connected to ground, and the drain D is electronically connected to a power source V (about 3.3V) via the resistor R. When the power data pin PWRGD outputs the high voltage signal, the MOSFET Q is turned on, and the voltage of the drain D is pulled down. When the power data pin PWRGD outputs the low voltage signal, the MOSFET Q is cut off, and the voltage of the drain D will not be pulled down.

The first buffer register 30 and the second buffer register 40 are both a logic component. The first buffer register 30 includes a power pin VCC, a grounding pin GND, an enable pin OE, four input pins A0, A1, A2, and A3, and four output pins Y0, Y1, Y2, and Y3, The power pin VCC is electronically connected to the power source V, and the grounding pin GND is connected to ground. The enable pin OE is electronically connected to the drain D of the MOSFET Q. When the enable pin OE receives a low voltage signal, the first buffer register 30 is enabled. The four input pins A0, A1, A2, and A3 are respectively connected to the alarm data pin ALARM, the system running data pin

ACT, the second hard disk data pin HDD-FLT, and the first hard disk data pin HDD-ACT. Signals output from the four output pins Y0, Y1, Y2, and Y3 are respectively determined by signals received by the four input pins A0, A1, A2, and A3. For example, when the input pin A0 receives the low voltage signal output from the alarm data pin ALARM, the output pin Y0 will output a low voltage signal (e.g., 3V); when the input pin A3 receives the pulses output from the first hard disk data pin HDD-ACT, the output pin Y3 will output pulses.

The second buffer register 40 includes a power pin VC, a grounding pin GD, an enable pin EN, two input pins I1 and I2, and two output pins O1 and O2. The power pin VC is electronically connected to the power source V, and the grounding pin GD is connected to ground. The enable pin EN is electronically connected to the drain D of the MOSFET Q. When the enable pin EN receives a low voltage signal, the first buffer register 40 is enabled. The input pin I1 is electronically connected to the drain D, and the input pin I2 is electronically connected to the bootstrap program data pin BOOT of the control circuit 10. Signals output from the two output pins O1 and O2 are respectively determined by signals received by the two input pins I1 and I2. For example, when the input pin I2 receives the low voltage signal output from the bootstrap program data pin BOOT, the output pin O2 will output a low voltage signal (e.g., 3V).

Cathodes of the LED1, LED2, LED3, LED4, LEDS, and LED6 are respectively connected to the output pins Y3, Y2, Y1, Y0, O2, O1, respectively via the current-limiting resistors RL1, RL2, RL3, RL4, RLS, RL6. Anodes of the LED1, LED2, LED3, LED4, LEDS, and LED6 are all electronically connected to the power source V. In one exemplary embodiment, the LED1, LED2, LED3, LED4, LEDS, and LED6 all can be positioned at the outside of a chassis (not shown) of the electronic device 200, for showing the running status of the power supply 210, the hard disk 230, and the motherboard 250.

The LED6 is used to show the running status of the power supply 210. If the power supply 210 is normal, the power data pin PWRGD outputs the high voltage signal. Then, the MOSFET Q is turned on, the voltage of the drain D is pulled down to enable the second buffer register 40. Thus, the output pin O1 outputs a low voltage signal (e.g., 3V) to turn on the LED6, for showing the power supply 210 is normal. If the power supply 210 is abnormal, the power data pin PWRGD outputs the low voltage signal. The MOSFET Q is cut off, and the second buffer register 40 is disabled. Thus, the LED6 will be turned off, for showing the power supply 210 is abnormal.

The LED1 and LED2 are used to show the running status of the hard disk 230. If the hard disk 230 is idle, the first hard disk data pin HDD-ACT outputs the low voltage signal, and then the output pin Y3 outputs a low voltage signal (e.g., 3V) to turn on the LED1, for showing the idle status of the hard disk 230. If the hard disk 230 is receiving/transmitting data, the first hard disk data pin HDD-ACT outputs pulses, and then the output pin Y3 outputs pulses to control the LED1 to twinkle, for showing the busy status of the hard disk 230. If the hard disk 230 is disabled, the second hard disk data pin HDD-FLT outputs the low voltage signal, and then the output pin Y2 outputs a low voltage signal (e.g., 3V) to turn on the LED2, for showing the disabled status of the hard disk 230. If the hard disk 230 is not installed, the first hard disk data pin HDD-ACT and the second hard disk data pin HDD-FLT both output the high voltage signal, and then the output pin Y3 and Y2 both output a high voltage signal (e.g., 5V). Thus, both of the LED1 and the LED2 will be turned off, for showing the uninstalled status of the hard disk 230.

The LEDS is used to show the running status of the operating system. If the electronic device 200 lacks the bootstrap program or the operating system has started, the bootstrap program data pin BOOT outputs the high voltage signal, and then the output pin O2 outputs a high voltage signal (e.g., 5V). Thus, the LEDS will be turned off to show the electronic device 200 lacks of bootstrap program or the operating system has been started. If the operating system is loading, the bootstrap program data pin BOOT outputs the low voltage signal, and then the output pin O2 outputs a low voltage signal (e.g., 3V) to turn on the LED5, for showing the operating system is loading.

The LED3 is used to show the running status of the motherboard 250. If the motherboard 250 is processing data, the system running data pin ACT outputs the low voltage signal, and then the output pin Y1 outputs a low voltage signal (e.g., 3V) to turn on the LED3, for showing the motherboard 250 is processing data. If the motherboard 250 is in the sleep mode or the power supply 210 is cut off, the system running data pin ACT outputs the high voltage signal, and then the output pin Y1 outputs a high voltage signal (e.g., 5V). Thus, the LED3 will be tuned off to show the motherboard 250 is in the sleep mode or the power supply 210 is cut off.

The LED4 is used to show the running status of the motherboard 250. If the motherboard 250 malfunctions, the alarm data pin ALARM outputs the low voltage signal, and then the output pin Y0 outputs a low voltage signal (e.g., 3V) to turn on the LED4, for showing the motherboard 250 malfunctions.

In other embodiments, the indication circuit 100 can show only the running status of the hard disk 230, and then the second buffer register 40 can be omitted. Similarly, the first buffer register 30 can be omitted when showing only the running status of the power supply 210.

The control circuit 10 can output different control signals according to running status of the components of the electronic device 200. The first buffer register 30 and the second buffer register 40 can output voltage signals corresponding to the signals from the control circuit 10 to turn on/off the LEDs. Thus, users can directly get running status of the components through the LEDs, but not need to open the chassis to check the components one at a time. Thereby, the indication circuit 100 is convenient and efficient.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An indication circuit for an electronic device, the indication circuit comprising:
a control circuit;
at least one light-emitting diode (LED); and
at least one buffer register electronically connected between the control circuit and the at least one LED;
wherein the control circuit outputs control signals according to a running status of the electronic device, the at least one buffer register receives the control signals, and outputs voltage signals to turn on/off the at least one LED according to the control signals.

2. The indication circuit as claimed in claim 1, further comprising a switch circuit, wherein the switch circuit includes a metallic oxide semiconductor field effect transistor (MOSFET) and a resistor, the MOSFET includes a gate, a source, and a drain, the gate is electronically connected to the control circuit, the source is connected to ground, and the drain is electronically connected to a power source via the resistor.

3. The indication circuit as claimed in claim 2, wherein the control circuit includes a power data pin electronically connected to the gate of the MOSFET, the power data pin outputs a high voltage signal or a low voltage signal for turning on/off the MOSFET.

4. The indication circuit as claimed in claim 3, wherein if a power supply of the electronic device is normal, the power data pin outputs a high voltage signal, if the power supply of the electronic device is abnormal, the power data pin outputs a low voltage signal.

5. The indication circuit as claimed in claim 2, wherein the indication circuit includes a first buffer register including an enable pin that is electronically connected to the drain of the MOSFET, and when the enable pin receives a low voltage signal, the first buffer register is enabled.

6. The indication circuit as claimed in claim 5, wherein the control circuit further includes an alarm data pin, a system running data pin, a first hard disk data pin, and a second hard disk data pin, the first buffer register further includes four input pins and four output pins, the four input pins are respectively connected to the alarm data pin, the system running data pin, the second hard disk data pin, and the first hard disk data pin, the four output pins are respectively connected to a cathode of one LED via a current-limiting resistor.

7. The indication circuit as claimed in claim 2, wherein the indication circuit includes a second buffer register including an enable pin that is electronically connected to the drain of the MOSFET, and when the enable pin receives a low voltage signal, the second buffer register is enabled.

8. The indication circuit as claimed in claim 7, wherein the control circuit includes a bootstrap program data pin, the second buffer register further includes two input pins and two output pins, the two input pins are respectively connected to the drain of the MOSFET and the bootstrap program data pin, the two output pins are respectively connected to a cathode of one LED via a current-limiting resistor.

9. The indication circuit as claimed in claim 6, wherein if a hard disk of the electronic device is idle, the first hard disk data pin outputs a low voltage signal, if the hard disk is receiving/transmitting data, the first hard disk data pin outputs pulses, if the hard disk is disabled, the second hard disk data pin outputs a low voltage signal, and if the hard disk is not installed, both the first hard disk data pin and the second hard disk data pin output a high voltage signal.

10. The indication circuit as claimed in claim 6, wherein if a motherboard of the electronic device is processing data, the system running data pin outputs a low voltage signal, and if the motherboard is in a sleep mode, the system running data pin outputs a high voltage signal.

11. The indication circuit as claimed in claim 6, wherein if a motherboard of the electronic device malfunctions , the alarm data pin outputs a low voltage signal.

12. The indication circuit as claimed in claim 8, wherein if an operating system of the electronic device is loading, the bootstrap program data pin outputs a low voltage signal, and if the electronic device lacks a bootstrap program or the operating system has started, the bootstrap program data pin outputs a high voltage signal.

13. The indication circuit as claimed in claim 1, wherein the at least one LED is positioned at the outside of the electronic device.

14. An indication circuit for an electronic device, the electronic device comprising a power supply, a hard disk, and a motherboard, the indication circuit comprising:
a control circuit;
a plurality of light-emitting diodes (LEDs); and
at least one buffer register electronically connected between the control circuit and the LEDs;
wherein the control circuit outputs control signals according to the running status of the power supply, the hard disk, and the motherboard, the at least one buffer register receives the control signals, and outputs voltage signals to the LEDs according to the control signals, for allowing the LEDs to respectively show the running status of the power supply, the hard disk, and the motherboard.

15. The indication circuit as claimed in claim 14, wherein if the power supply is normal, one LED is lit, if the power supply is abnormal, the one LED is not lit.

16. The indication circuit as claimed in claim 14, wherein if the hard disk is idle, one LED is lit, if the hard disk is receiving/transmitting data, the one LED twinkles, and if the hard disk is not installed, the one LED is not lit.

17. The indication circuit as claimed in claim 14, wherein if the motherboard is processing data, one LED is lit, and if the motherboard is in a sleep mode, the one LED is not lit.
